(19) United States
(12) Patent Application Publication
(10) Pub. No.: US 2004/0032843 A1
(43) Pub. Date: Feb. 19, 2004

(54) Push-to-talk/cellular networking system

(76) Inventors: Bradley R. Schaefer, Chandler, AZ (US); Mark L. Shaughnessy, Phoenix, AZ (US); Peter J. Armbruster, Chandler, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/222,233

(22) Filed: Aug. 15, 2002

(51) Int. Cl. H04Q 7/24

(52) U.S. Cl. 370/338; 370/466

(57) ABSTRACT

A mobile device (80) is coupled to a dispatch server (50) via a mobile network (60, 70) and an internet protocol network (40). The mobile device triggers a push-to-talk request which is processed by the dispatch server. The dispatch server then transmits this push-to-talk request to a family radio service (FRS) gateway (30). FRS gateway (30) converts this digital request to an analog request and broadcasts the request via a base station 20 to a family service radio (10). The FRS radio can broadcast back to the FRS gateway, which will vocode the analog request, and transmit it back to the mobile device via the dispatch server. This invention allows mobile devices (cellular) equipped with PTT applications to network with FRS radios.

### BACKGROUND OF THE INVENTION

The present invention pertains to mobile telecommunications systems and more particularly to inter-operability between push-to-talk applications on mobile cellular system and push-to-talk capabilities on family radio systems. .

Conventional cellular networks and cell phones operate only with a cellular network and other cell phones. In these days of feature-laden cell phones, the cost of such cell phones may be quite expensive. Cellular phones are flexible however, and with the exception of a proprietary Nextel system, at present they do not provide any push-to-talk inter-operability. In addition, even though the cost of service for cellular phones has dropped substantially, they are still expensive to use for many members of a family, for example.

In modern society, family communication is essential. Especially essential is communication from parents to their children. To address these issues of modern society, there are many family radio service (FRS) type wireless communication devices. One such family radio service radio device is a Talkabout® radio manufactured and sold by Motorola, Inc. Such family radio service radios are basically multi-channeled direct line of sight communication walkie-talkie type devices. These FRS radios are typically inexpensive and durable and therefore suitable for use by children. These FRS radios are typically push-to-talk (PTT) radio devices.

Most adult family members have and use cell phones. However, cell phones are not compatible with FRS type radios. Most cell phones typically do not provide a push-to-talk functions or applications.

Communication between parents and children or adult authority and children is particularly useful in places like a shopping mall, a sporting stadium or a school.

Accordingly, it would be highly desirable to have a method and means for interfacing cellular phones with new embedded push-to-talk applications with family radio service type radios.

### BRIEF DESCRIPTION OF THE DRAWING

FIG. 1 is a block diagram of a inter-operability network in accordance with the present invention.

FIG. 2 is a call flow diagram depicting the methodology in accordance with the present invention.

### DESCRIPTION OF THE PREFERRED EMBODIMENT OF THE INVENTION

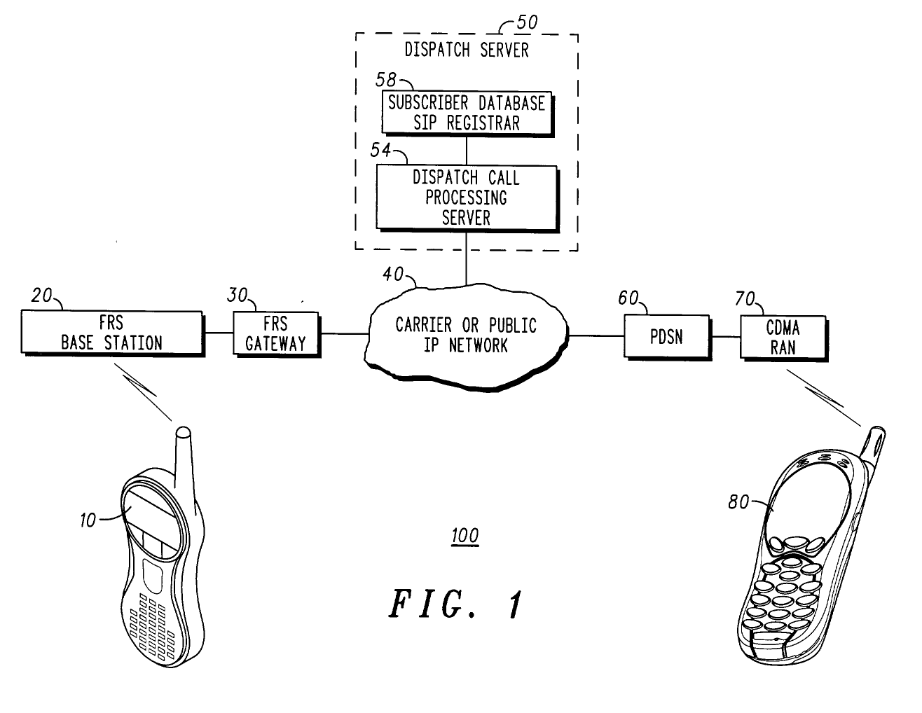

Referring to FIG. 1, a block diagram of a family radio service (FRS) inter-working with a CDMA (code division multiple access) mobile phone network is shown. Radio 10 is a family radio service type radio or any conventional two-way radio. FRS radio or gateway means either FRS type radios and gateways or any conventional two-way radio system or computer terminal. FRS radio 10 may comprise a Talkabout® radio made and sold by Motorola, Inc. FRS radio 10 is coupled via wireless link to FRS receiver/base station 20 in the present invention. Typically FRS radios may operate autonomously in a “walkie-talkie” type mode communicating directly with each other. That is, FRS radios may operate on direct line-of-sight, local transmission with channel and security selectivity.

This invention includes an FRS base station for transceiving FRS communications. FRS base station 20 may couple many FRS radios to FRS gateway 30. FRS radios typically are analog coded radios. Cellular networks carry voice in vocoder (vocoded) formats. FRS gateway 30 converts the analog FRS radios to cellular network compatible, SIP based voice on IP (VOIP) formats and vice-a-versa.

Further, FRS gateway 30 provides a session initiation protocol (SIP) client interface to dispatch server 50. This function will be discussed infra.

FRS gateway 30 is coupled to carrier or public internet protocol (IP) network 40. Network 40 may comprise a number of different kinds and types of networks. All networks which pass through network 40 must be able to carry SIP protocols, which is an application protocol which is carried by standard IP protocols. Network 40 is coupled to dispatch server 50 and to packet data switching node 60. Dispatch server 50 includes dispatch call processing server 54 and subscriber data base SIP registrar 58 which is coupled to dispatch call processing server 54. Dispatch server 50 including dispatch call processing server 54, subscriber data bases and a session initiation protocol registrar 58 serve to interface a CDMA cellular phone which has a push-to-talk feature with the FRS network comprising FRS gateway 30 and FRS base station 20.

Network 40 is also coupled to packet data switching node 60. Packet data switching node 60 performs the associated packet routing and switching functions for a cellular network. Packet data switching node 60 is further coupled to a CDMA RAN (radio access network) 70. CDMA RAN performs the wireless interface between the cellular network comprising packet data switching node 60 and RAN 70 and a CDMA cell phone user 80. Although a CDMA RAN and PDSN are show for example, any cellular network can be used with this invention. The RAN may be one of: a code division multiple access (CDMA) RAN, a time division multiple access RAN, a general packet radio service (GPRS) RAN, or a universal mobile telecommunication s service. If the RAN is a CDMA RAN or a TDMA RAN, then the switching node includes a packet data switching node (PDSN). If the RAN is a GPRS or UMTS RAN, then the switching node may a signaling GPRS service node (SGSN )and gateway GPRS service node (GGSN).

Cellular phone 80 is a CDMA type handset in the preferred embodiment. CDMA cell phone 80 will be modified to include a push-to-talk client application software. In the preferred embodiment this software is written in Java® language. The push-to-talk client application software may also be written in one of the following programming languages C, C++, or Qualcomm BREW®.

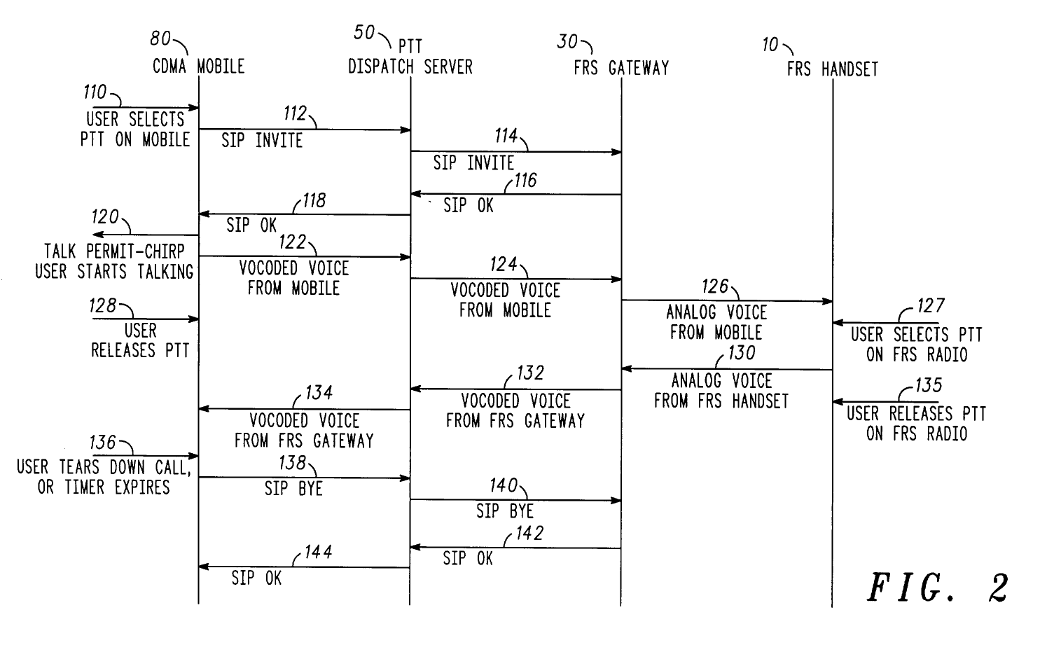

Referring to FIG. 2, a call flow diagram of a method for inter-working a family radio service radio with a push-to-talk capable CDMA cell phone is shown.

Initially the cell phone user 80 selects the push-to-talk function on the phone, 110. Since mobile phone 80 has been updated to include the push-to-talk client application, it produces a SIP invite message 112 which is transmitted through CDMA RAN 70, through packet data switching node 60, through network 40 to dispatch server 50. The SIP invite message will includes an identity of a family radio service gateway, which is serving a particular location/region. This identity will include a particular channel in the family radio service band and security code, and even possibly the base station location. The identities may include, for example, a channel number, security code, a destination such as a mall, school or sports stadium and the carrier operating that base station, such as Verizon Communications, for example.

Next, dispatch server 50 transmits this SIP invite message to the family radio service (FRS) gateway at the mall, sporting stadium or school 114. At this point, the FRS gateway will now have the identity of a CDMA user(via SIP signaling) that wishes to participate in all “dialogs” that occur on a particular channel and security code. A SIP OK message 116 is returned from the FRS gateway 30 to the dispatch server 50. Also the SIP OK message is returned 118 from the dispatch server 50 to the mobile phone 80. The user of the mobile phone 80 is informed to initiate speaking by an audible “chirp” sound and begins speaking 120.

Next, the speaker on cell phone 80 has his voice vocoded by the CDMA mobile phone and transmitted 122 to the dispatch server 50. Dispatch server forwards (transmits) 124 the vocoded voice from the cell phone 80 to the FRS gateway 30. Next, gateway 30 converts the vocoded voice from the CDMA mobile phone 80 to an analog form 126. Gateway 30 then broadcasts over the air the analog voice to any radio listener on the particular channel and security code that was given in the initial SIP invite message, 114.

In response the FRS radio or handset 10 will have its speaker initiate via a PTT button on the FRS radio, 127. The user of mobile device 80 then releases 128 the PTT function on the mobile device 80. Next, the FRS radio 10 transmits an analog voice message on the selected channel with the specified security code 130. This voice is transmitted from FRS handset 10 to FRS gateway 30. Then FRS gateway vocodes the analog voice to a form compatible with the CDMA cell phone 80 and transmits this message 132 to the dispatch server 50. Dispatch server 50 then forwards (transmits) message 134 the vocoded voice to the mobile phone 80. The user of the FRS radio 10 then releases 135 the PTT function of the FRS radio or handset 10.

The FRS Gateway has a squelch setting that would prevent noise from being vocoded when no strong FRS radio transmissions are occurring. Therefore, unless a certain power level transmission occurs from the FRS radio to the gateway, the FRS gateway will not vocode traffic into the IP network to the CDMA mobile user.

After one or more such alternating message transmissions, the mobile phone user may decide to end the call or an overall timer may expire 136. In this case, a SIP BYE message is generated by the mobile phone 80 and transmitted 138 to dispatch server 50. Again, this SIP BYE message will include the channel identity, security code, destination gateway and base station and the service operator, such as Verizon Communication. It will also include the identity of the mobile phone and its service operator.

This SIP BYE message is transmitted 140 from dispatch server 50 to FRS gateway 30. Message includes the same information specified in the original SIP BYE message 138. This effectively ends the call between the handset 10 and the mobile phone 80. A SIP OK message is returned 142 from the gateway 30 to the dispatch server 50. Lastly, the dispatch server returns the SIP OK message to the mobile phone 80.

In order to establish the push-to-talk inter-working with an FRS network for a CDMA type cell or mobile phone 80, it is necessary that the user of the cell phone 80 not only register with the dispatch server 50 but associate itself with the FRS gateway 30. There are several options in accordance with the present invention for mobile cellular phone 80 to be associated with a particular FRS gateway 34, for example.

The first method for a mobile subscriber 80 associating with the FRS gateway 30 would be for gateway 30 to treat the incoming call from the mobile unit 80 as a private call. This would be accomplished by sending a duration for the subscription in SIP invite message 112 and 114 which is received by gateway 30. Also, the gateway may have a default duration for incoming push-to-talk calls. As a result, mobile unit 80 would receive all traffic on the traffic channel allocated to the FRS handsets having the particular security code for the time specified in the initial SIP invite. The user would then be required to decipher his particular radio handset from the others which might be present. This solution is transparent to the infrastructure of the system.

After the period of time expires, the FRS Gateway would release the binding, and release the session per the SIP Bye method described previously.

A second option is to treat the connection between the mobile unit 80 and the FRS gateway 30 as existing for a fixed duration. For example, a duration might be 30 minutes. For the 30 minute interval, messages 132 and 134 would contain all of the FRS speakers on that channel with that particular security code. Mobile unit 80 would receive all such voice from any FRS radio handset 10 for the entire 30 minutes. After the 30 minute duration, the mobile unit 80 would not receive any new traffic via messages 132 and 134 from gateway 30. This option is also transparent to the telecommunications infrastructure; however, a disadvantage is that all traffic on the FRS channel will be transmitted via messages 132 and 134 back to mobile unit 80 which may prevent the call from expiring for a long time, 30 minutes. This may tie up infrastructure services and equipment needlessly.

A third method for establishing inter-operability with the FRS gateway 30 is to provide explicit subscribe/unsubscribe signaling (activated by user actions, or preconfigured timers in the cellular handset 80) or as an attribute within the SIP invite and SIP response messages. Again, this option is transparent to the telecommunication infrastructure; however, logic is required within the mobile unit 80 to interpret the FRS gateway 30 signaling and inter-working.

As can be realized from the above explanation, the present invention provides a capability to interface and inter-operate existing FRS radios with push-to-talk capable cell phones. Furthermore, this method and apparatus provides an expansion of service for cellular users, in that the cellular users may subscribe and participate with FRS talk groups or individuals. Lastly, the present invention provides for a new business opportunity for mobile or cellular network operators to provide communications coverage between modern cell phones and low-cost FRS radio systems. Such inter-operability is particularly effective in shopping malls or schools.

This could easily be applied to GSM/GPRS, UMTS, and IS-136 TDMA systems in addition to IS-95 CDMA and CDMA 2000 systems.

Although the preferred embodiment of the invention has been illustrated, and that form described in detail, it will be readily apparent to those skilled in the art that various modifications may be made therein without departing from the spirit of the present invention or from the scope of the appended claims.

1. An arrangement for providing inter-operability by a mobile device and a family radio service (FRS) radio comprising:
a mobile network for coupling the mobile device for communication; and
a FRS gateway coupled to the FRS radio and to the mobile network, the FRS gateway for converting analog signals from the FRS radio and digital signals from the mobile device.

2. The arrangement as claimed in claim 1, wherein there is further included a dispatch server coupled to the mobile device via the mobile network and the FRS gateway, the dispatch server routing a push-to-talk (PTT) request from the mobile device.

3. The arrangement as claimed in claim 2, wherein the FRS gateway further provides session initiation protocol interface with the dispatch server.

4. The arrangement as claimed in claim 2, wherein there is further included an internet protocol (IP) network coupled between the FRS gateway, the dispatch server and the mobile network, the IP network for transmitting packet data among the FRS gateway, the dispatch server and the mobile network.

5. The arrangement as claimed in claim 4, wherein the mobile network includes:
a radio access network (RAN) for wirelessly coupling the mobile device; and
a switching node (SN) coupled to the RAN and to the IP network.

6. The arrangement as claimed in claim 5, wherein:
the RAN includes one of:
a code division multiple access (CDMA) RAN, a time division multiple access RAN, a general packet radio service (GPRS) RAN, universal mobile telecommunication s service;
if the RAN is a CDMA RAN or a TDMA RAN, then the SN includes a packet data switching node (PDSN); and
if the RAN is a GPRS or UMTS RAN, then the SN includes a signaling GPRS service node (SGSN) and gateway GPRS service node (GGSN).

7. The arrangement as claimed in claim 5, wherein the dispatch server includes a dispatch call processing server for routing packet data between the mobile device and the IP network.

8. The arrangement as claimed in claim 7, wherein the dispatch server further includes a subscriber data base for indicating which mobile device may transmit the push-to-talk request, the subscriber data base coupled to the dispatch call processing server.

9. The arrangement as claimed in claim 2, wherein the FRS gateway includes an FRS base station coupled wirelessly to the FRS radio for receiving and transmitting wirelessly analog signals to and from the FRS radio and to and from the FRS gateway.

10. The arrangement as claimed in claim 2, wherein the mobile device includes a CDMA handset.

11. The arrangement as claimed in claim 10, wherein the CDMA handset includes means for providing a push-to-talk (PTT) function.

12. The arrangement as claimed in claim 11, wherein the means for providing the PTT function is a program.

13. The arrangement as claimed in claim 11, wherein the means for providing the PTT function is a program written in one language of a group:
Java® , C, C++ or Qualcomm BREW®.

14. A method for networking a mobile device with a family radio service (FRS) radio comprising the steps of:
transmitting by the mobile device a session initiation protocol (SIP) invite message including at least a destination to a dispatch server;
sending by the dispatch server the SIP invite message to an FRS gateway associated with the destination; and
converting digital signals from the mobile device to analog signals for transmission to the FRS radio and for converting analog signals from the FRS radio to digital signals for transmission to the mobile device by the FRS gateway.

15. The method as claimed in claim 14, wherein there is further included a step of selecting by the mobile device a push-to-talk function to enable the step of transmitting the SIP invite message.

16. The method as claimed in claim 14, wherein there is further included a step of transmitting, by the mobile device, vocoded data to the dispatch server.

17. The method as claimed in claim 16, wherein there is further included the step transmitting the vocoded data by the dispatch server to the FRS gateway.

18. The method as claimed in claim 17, wherein the step of converting further includes the steps of:
converting the vocoded-data to analog voice data by the FRS gateway;
broadcasting the analog voice data on a designated channel and a security code;
receiving the analog voice data on the designated channel and the security code by the FRS gateway; and
converting the analog voice data received on the designated channel and the security code to vocoded voice data.

19. The method as claimed in claim 18, wherein there is further included the step of transmitting by the FRS gateway the vocoded data to the dispatch server.

20. The method as claimed in claim 19, wherein there is further included the step of transmitting by the dispatch server the vocoded data to the mobile device.

21. The method as claimed in claim 14, wherein the step of transmitting a session initiation protocol message includes the step of inserting by the mobile device in the session initiation protocol message an attribute indicating a duration of a push-to-talk feature.

22. The method as claimed in claim 14, wherein there is further included a step of maintaining by the FRS gateway a push-to-talk feature for a fixed duration of time.

23. The method as claimed in claim 14, wherein there is further included steps of:
indicating in the SIP invite message a activation of a push-to-talk feature with the FRS Gateway; and
indicating within the SIP invite message a deactivation of a push-to-talk feature with the FRS gateway.
